(19) United States
(12) Patent Application Publication
(10) Pub. No.: US 2018/0022868 A1
(43) Pub. Date: Jan. 25, 2018

(54) ALIPHATIC POLYESTER COMPOSITION, MOLDED PRODUCT, AND MANUFACTURING METHOD OF ALIPHATIC POLYESTER

(71) Applicant: Kureha Corporation, Tokyo (JP)

(72) Inventors: HIROYUKI SATO, Tokyo (JP); TAKAHIRO WATANABE, Tokyo (JP); FUMINORI KOBAYASHI, Tokyo (JP)

(21) Appl. No.: 15/548,453

(22) PCT Filed: Mar. 28, 2016
(86) PCT No.: PCT/JP2016/059966

§ 371 Date: Aug. 3, 2017

(30) Foreign Application Priority Data
Mar. 30, 2015 (JP) 2015-070267

(51) Int. Cl. C08G 63/85; C08J 5/18; C08J 5/00; C08G 63/08

(52) U.S. Cl. CPC C08G 63/85; C08G 63/08; C08J 5/18; C08J 5/00; C08J 2367/00

(57) ABSTRACT

A method of continuously manufacturing an aliphatic polyester composition from a cyclic ester and the like, wherein the temperature in an extruder is increased in two or more stages from a raw material supply port to a discharge port, the temperature at the discharge port is a temperature where the melt viscosity of the composition at the discharge port is from 100 to 2000 Pa·s, the free acid concentration in the cyclic ester is 10 eq/t or less, and the unreacted cyclic ester concentration in the composition is less than 2 wt. %.

### TECHNICAL FIELD

The present invention relates to an aliphatic polyester composition, molded product, and manufacturing method of an aliphatic polyester.

### BACKGROUND ART

A method of continuously manufacturing an aliphatic polyester composition from a cyclic ester is known to provide an aliphatic polyester composition by melt-kneading a cyclic ester in an extruder, and then polymerizing.

Unreacted cyclic esters included in the aliphatic polyester composition will increase unless the cyclic ester is sufficiently reacted in the extruder. As a result, an aliphatic polyester composition cannot be stably and continuously manufactured.

Patent Literature 1 describes a resorbable polyester polymerizing method of introducing a mixture of a cyclic ester, catalyst, and alcohol from an extruder hopper, controlling the temperature in the extruder by zone to polymerize the reaction mixture, and adjusting the residence time of the reaction mixture in the extruder to control the conversion ratio of the reaction mixture.

Patent Literature 2 describes a method of continuously manufacturing an aliphatic polyester by supplying material with a high melt viscosity to an extruder to control the melt viscosity of the content at a raw material supply port of the extruder to a higher viscosity gradient than the viscosity of the content at a tip end of the extruder.

Patent Literature 3 describes a method of polymerizing in an extruder an aliphatic ester component such as ε-caprolactone or the like with a low acid value and low water content, and then supplying product discharged from the extruder to a single screw extruder or gear pump attached downstream of the extruder to obtain a film-shaped aliphatic polyester polymer.

### CITATION LIST

### Patent Literature

### Patent Literature 1: WO 90/05157 (Published May 17, 1990)

### Patent Literature 2: Japanese Unexamined Patent Application Publication No. “JP-A-2003-252975 (Published Sep. 10, 2003)”

### Patent Literature 3: Japanese Unexamined Patent Application “JP-T-11-510549 (Published Sep. 14, 1999)”

### SUMMARY OF INVENTION

### Technical Problem

However, as a result of extensive studies, the present inventors discovered that a reaction of a cyclic ester or the like in an extruder is insufficient with the technology disclosed in Patent Literature 1, and an aliphatic polyester composition cannot be stably and continuously manufactured.

Furthermore, even with the manufacturing method of Patent Literature 2, it was discovered that the amount of unreacted cyclic esters included in the aliphatic polyester composition after the polymerization reaction was high, and therefore, reaction of the cyclic esters in the extruder was not sufficient. Therefore, a method of manufacturing an aliphatic polyester composition at a higher reaction rate was required.

Furthermore, Patent Literature 3 describes that complete conversion to an aliphatic polyester was achieved from ε-caprolactone, but does not describe manufacturing an aliphatic polyester at a high reaction rate from other cyclic esters.

In light of the foregoing, an object of the present invention is to provide a method of stably and continuously manufacturing an aliphatic polyester composition at a high reaction rate from a cyclic ester.

### Solution to Problem

As a result of extensive studies to resolve the aforementioned problems, the present inventors achieved the following present invention.

A manufacturing method of an aliphatic polyester according to the present invention is a method of continuously manufacturing an aliphatic polyester composition, including a step of supplying a cyclic ester, molecular weight adjusting agent, and polymerization catalyst to an extruder and then polymerizing in the extruder; where the temperature in the extruder is gradually increased in two or more stages from a raw material supply port to a discharge port, the temperature at the discharge port is a temperature where the melt viscosity of the composition at the discharge port is from 100 to 2000 Pa·s, the free acid concentration in the cyclic ester is 10 eq/t or less, and the unreacted cyclic ester concentration in the aliphatic polyester composition is less than 2 wt. %.

A manufacturing method of an aliphatic polyester molded product according to the present invention includes a step of molding an aliphatic polyester composition manufactured by the aforementioned manufacturing method of an aliphatic polyester composition into a fibrous form, sheet form, film form, rod form, plate form, or pellet form.

A manufacturing method of an aliphatic polyester according to the present invention is a method of continuously manufacturing an aliphatic polyester, including a step of supplying a cyclic ester, molecular weight adjusting agent, and polymerization catalyst to an extruder and then polymerizing in the extruder; where the temperature in the extruder is gradually increased in two or more stages from a raw material supply port to a discharge port, the temperature at the discharge port is a temperature where the melt viscosity of the aliphatic polyester at the discharge port is from 100 to 2000 Pa·s, the free acid concentration in the cyclic ester is 10 eq/t or less, and the unreacted cyclic ester concentration in the aliphatic polyester is less than 2 wt. %.

### Advantageous Effects of Invention

The present invention achieves an effect where an aliphatic polyester can be stably and continuously manufactured at a high reaction rate from a cyclic ester.

### BRIEF DESCRIPTION OF DRAWINGS

FIG. 1 is a relationship diagram between the polymerization temperature and unreacted glycolide concentration in a polyglycolic acid composition, for an embodiment of a manufacturing method of an aliphatic polyester composition according to the present invention.

FIG. 2 is a relationship diagram between the polymerization time and reaction rate of glycolide or the like, for an embodiment of a manufacturing method of an aliphatic polyester composition according to the present invention.

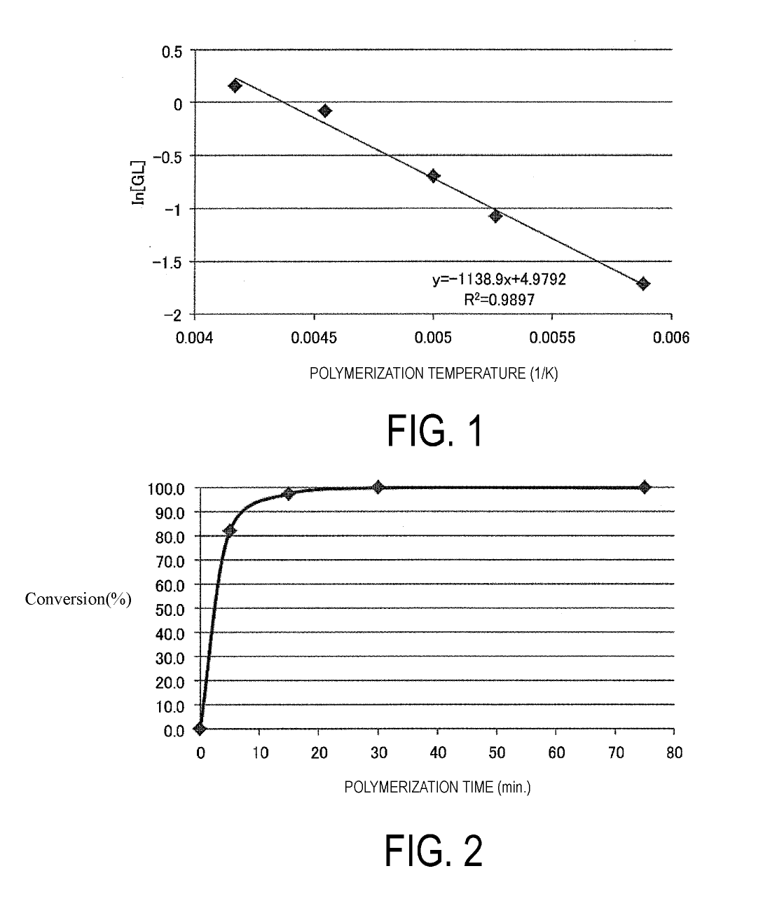

### DESCRIPTION OF EMBODIMENTS

Manufacturing Method of an Aliphatic Polyester Composition

A manufacturing method of an aliphatic polyester composition according to the present invention is a method of continuously manufacturing an aliphatic polyester composition, including a step of supplying a cyclic ester, molecular weight adjusting agent, and polymerization catalyst to an extruder and then polymerizing in the extruder; where the temperature in the extruder is gradually increased in two or more stages from a raw material supply port to a discharge port, the temperature at the discharge port is a temperature where the melt viscosity of the composition at the discharge port is from 100 to 2000 Pa·s, the free acid concentration in the cyclic ester is 10 eq/t or less, and the unreacted cyclic ester concentration in the aliphatic polyester composition is less than 2 wt. %.

An aliphatic polyester can be stably and continuously manufactured at a high reaction rate from a cyclic ester by the aforementioned composition.

A specific example of a manufacturing method of an aliphatic polyester composition and molded product according to the present invention is described below.

Step 1

First, a cyclic ester, molecular weight adjusting agent, and polymerization catalyst are mixed under dry conditions. Next, the mixture is continuously supplied to a raw material supply port of an extruder.

In the present embodiment, the cyclic ester, molecular weight adjusting agent, and polymerization catalyst are mixed before introducing into the extruder. With the manufacturing method of an aliphatic polyester composition according to the present invention, the cyclic ester, molecular weight adjusting agent, and polymerization catalyst may be introduced to the raw material supply port of the extruder without mixing, but are preferably mixed before introducing. By mixing before introducing, uniformity is increased, and an aliphatic polyester is more easily and stably manufactured.

Furthermore, in the present embodiment, mixing is performed under dry conditions, but with the manufacturing method of an aliphatic polyester composition according to the present invention, mixing is not necessarily performed under dry conditions when mixing. However, mixing is preferably performed in a dry room, in an inert gas atmosphere such as dry nitrogen or the like, or under reduced pressure, from the perspective of preventing mixing of moisture which adversely affects the polymerization rate and the like.

Cyclic Ester

Lactones and bimolecular cyclic esters (hereinafter, referred to as cyclic dimer) of an α-hydroxycarboxylic acid are preferred as the cyclic ester used in the manufacturing method of an aliphatic polyester according to the present embodiment for example.

Examples of α-hydroxycarboxylic acids that form a cyclic dimer include glycolic acid, L- and/or D-lactic acid, α-hydroxybutyric acid, α-hydroxyisobutyric acid, α-hydroxyvaleric acid, α-hydroxycaproic acid, α-hydroxyisocaproic acid, α-hydroxyheptanoic acid, α-hydroxyoctanoic acid, α-hydroxydecanoic acid, α-hydroxymyristic acid, α-hydroxystearic acid, alkyl-substituted products thereof, and the like.

Examples of lactones include β-propiolactone, β-butyrolactone, pivalolactone, γ-butyrolactone, δ-valerolactone, β-methyl-δ-valerolactone, ε-caprolactone, and the like.

A cyclic ester containing an asymmetric carbon may be in a D-form, L-form, or racemic form. The cyclic esters can be used independently or in a combination of two or more types.

The cyclic ester can be copolymerized with another copolymerizable comonomer as desired. Examples of other monomers include cyclic monomers such as trimethylene carbonate, and 1,3-dioxane, the aforementioned α-hydroxycarboxylic acid, ethylene oxalate, molar mixtures of aliphatic diols and aliphatic carboxylic acids, and the like.

Of the cyclic esters, a glycolide which is a cyclic dimer of glycolic acid, L- and/or D-lactides which are cyclic dimers of L- and/or D-lactic acid, and ε-caprolactone are preferable, and a glycolide is more preferable. The manufacturing method according to the present embodiment can be particularly preferably applied to manufacturing a polyglycolic acid composition by glycolide ring-opening polymerization.

The free acid concentration in the cyclic ester is preferably 10 eq/t or less, more preferably 8 eq/t or less, and even more preferably 5 eq/t or less. When the concentration is 10 eq/t or less, the polymerization rate is high, and therefore, the cyclic ester is sufficiently reacted, and thus an aliphatic polyester composition can be stably obtained at a high reaction rate.

Molecular Weight Adjusting Agent

Examples of the molecular weight adjusting agent used in the manufacturing method of an aliphatic polyester according to the present embodiment include alcohols, amines, and the like, and alcohols are preferred. Thereby, discoloring of the generated aliphatic polyester can be suppressed. Furthermore, examples of the alcohols include monohydric alcohols, dihydric alcohols, polyhydric alcohols that are trihydric or higher, and the like, and dihydric alcohols or higher are preferred. By using a dihydric alcohol or higher as the molecular weight adjusting agent, the polymerization rate of the cyclic ester is higher than when a monohydric alcohol is added. Of these, a dihydric alcohol is more preferably used. By using a dihydric alcohol as the molecular weight adjusting agent, an aliphatic polyester can be produced where the molecular weight and properties of the generated aliphatic polyester essentially do not change, as compared to when adding a monohydric alcohol. When a polyhydric alcohol that is trihydric or higher is used as the molecular weight adjusting agent, the aliphatic polyester that is eventually obtained will have a branched structure. Therefore, the properties of the generated aliphatic polyester change as compared when a monohydric alcohol is added.

The added amount of the molecular weight adjusting agent is preferably from 0.11 mol % to 2 mol %, and more preferably from 0.15 mol % to 1 mol %. So long as the amount is within the aforementioned preferred range, the molecular weight of the eventually obtained aliphatic polyester can be controlled while increasing the polymerization rate of the cyclic ester, and mechanical properties that can withstand actual use can be achieved.

Herein, the free acid of the cyclic ester functions with the same functions as the molecular weight adjusting agent. Therefore, when considering the total amount of the added amount of the molecular weight adjusting agent with regard to the cyclic ester and the amount of hydroxyl groups of free acids in the cyclic ester with regard to the cyclic ester, the total amount is preferably from 0.13 mol % to 2.2 mol %, and more preferably from 0.15 mol % to 2.0 mol % with regard to the cyclic ester.

Polymerization Catalyst

The polymerization catalyst used in the manufacturing method of an aliphatic polyester according to the present embodiment may be a ring-opening polymerization catalyst for various cyclic esters, and is not particularly limited. Examples of the polymerization catalyst include oxides, chlorides, carboxylates, and alkoxides of tin, titanium, aluminum, antimony, zirconium, zinc, and other metal compounds, and the like.

Preferred examples of the polymerization catalyst include: tin compounds such as tin dichlorides, tin tetrachlorides, other tin halides, tin octanoate, tin octylate, and other organic tin carboxylates; alkoxytitanate and other titanium compounds; alkoxyaluminum and other aluminum compounds; zirconium acetylacetone and other zirconium compounds; antimony halides; and the like.

The amount of the polymerization catalyst is preferably from 10 ppm to 600 ppm by mass ratio, and more preferably 15 ppm to 300 ppm, with regard to the cyclic ester. When the amount of the catalyst is less than 600 ppm, the thermal stability of the eventually obtained aliphatic polyester will be excellent. Furthermore, in a manufacturing step, polymerization of the cyclic ester in a segment on the raw material supply port side in the extruder is suppressed, and thus blockage in the extruder can be prevented from occurring, and the load on a motor can be prevented from increasing. Furthermore, when the amount is 10 ppm or higher, a polymerization rate sufficient for the cyclic ester is achieved. In other words, when the amount is within the aforementioned preferred range, problems in the extruder or the like can be prevented from occurring while increasing the polymerization rate of the cyclic ester.

Other Components

With the manufacturing method of an aliphatic polyester according to the present embodiment, a common filler, antioxidant, ultraviolet absorber, and various other components may be further introduced into the extruder if necessary.

Step 2

Next, the cyclic ester, molecular weight adjusting agent, and polymerization catalyst are reacted in the extruder to generate an aliphatic polyester composition.

At this time, the temperature in the extruder is set to gradually increase in two or more stages from the raw material supply port to the discharge port. Thereby, the melt viscosity of the content in the extruder has a gentle gradient from the raw material supply port to the discharge port of the extruder.

Herein, if the extruder has a plurality of zones in which the temperature can be independently controlled from the raw material supply port to the discharge port, the temperature is increased in stages, where as one stage, one zone adjacent on the discharge side of another zone has a temperature that is preferably 1° C. or higher, more preferably 5° C. or higher, as compared to the other zone.

Furthermore, the temperature increasing in stages from the raw material supply port to the discharge port refers not only to a case where the temperature of a zone adjacent on a discharge side to another zone is higher occurs two or more times from the raw material supply port to the discharge port within the aforementioned preferred temperature range, but also indicates that the temperature from the raw material supply port to the discharge port does not decrease. In other words, a condition where the temperature of a zone adjacent on a discharge side to another zone to the other certain zone on a discharge side is lower than the other zone even one time does not correspond to “the temperature in the extruder gradually increasing in two or more stages from the raw material supply port to the discharge port”, even if a condition where the temperature of a zone adjacent on a discharge side of another zone is higher occurs two or more times from the raw material supply port to the discharge port within the aforementioned preferred temperature range. On the other hand, a case where the temperature of a zone adjacent on a discharge side to another zone is at the same temperature as the other zone, corresponds to “the temperature in the extruder gradually increases in two or more stages from the raw material supply port to the discharge port”, so long as a condition where the temperature of a zone adjacent on the discharge port side to another zone is higher occurs two or more times from the raw material supply port to the discharge port within the aforementioned preferred temperature range.

The number of stages where the temperature increases is preferably two or more stages, but is more preferably within a range of 2 to 10 stages, and even more preferably within a range of 2 to 5 stages. When the number of stages where the temperature increases is set to two or more stages, the melt viscosity of the content in the extruder gently increases towards the raw material supply port. In other words, the melt viscosity of content in the extruder can have a more gentle gradient towards the raw material supply port. Therefore, an operation is possible with sufficient transportability. Note that so long as the temperature gradually increases in two or more stages, the position of the zones in which the temperature increases is not limited, and the temperature may increase in two stages near the raw material supply side or near the discharge side, the temperature may increase in one stage on the raw material supply side and in one stage on the discharge side, or the temperature may increase in one stage of each of the raw material supply side, center vicinity, and discharge side, for example.

At this time, the temperature can be appropriately adjusted while monitoring the concentration of unreacted cyclic esters in the generated aliphatic polyester or the load on the extruder motor.

The temperature at the raw material supply port of the extruder is preferably within a range of 80° C. to 200° C., and more preferably within a range of 100° C. to 180° C. When the temperature is 200° C. or lower, reduction of the melt viscosity of the content on the raw material supply side can be suppressed, and the transportability can be prevented from decreasing. When the temperature is 80° C. or higher, a polymerization reaction sufficient for the cyclic ester can be performed. In other words, when the temperature is within the aforementioned preferred range, operation is possible with sufficient transportability and reaction rate.

The temperature at the discharge port of the extruder must be a temperature where the melt viscosity of the aliphatic polyester composition at the discharge port is from 100 to 2000 Pa·s, and the concentration of unreacted cyclic esters in the obtained aliphatic polyester composition is less than 2 wt. %. Herein, the temperature where the concentration of unreacted cyclic esters in the obtained aliphatic polyester composition is less than 2 wt. % varies based on the type of aliphatic polyester composition. The present embodiment describes a case where a polyglycolic acid composition is manufactured from a glycolide. If a reaction between a glycolide and a polyglycolic acid composition is in a state of equilibrium, the temperature at the discharge port of the extruder is required to be lower than 265° C. This is because the reaction between the glycolide and polyglycolic acid composition is an equilibrium reaction, and the temperature has an upper limit based on a relationship between the concentrations of the equilibrium monomers. Note that conditions where the temperature at the discharge port of the extruder is lower than 265° C. were determined by the following experiment. In other words, a polymerization reaction was performed until the unreacted glycolide concentration [GL] in the polymerization reaction system did not change, with the polymerization temperature set to be constant, and [GL] was measured when rapidly cooled. This was performed at several polymerization temperatures. The relationship between the natural logarithm ln [GL] of [GL] and the reciprocal 1/T (unit: K⁻¹) of the polymerization time T was plotted on a graph to determine the relational expression between [GL] and the polymerization temperature T. Based on the relational expression, when the polymerization temperature for achieving [GL] of less than 2 wt. % is extrapolated, a temperature of approximately 265° C. is achieved.

Note that the present embodiment describes a case where a polyglycolic acid composition is manufactured from a glycolide, but even if an aliphatic polyester composition is manufactured from another cyclic ester, the temperature conditions can be set by the same technique if a reaction between the aliphatic polyester and cyclic ester is in a state of equilibrium.

From the aforementioned, in order to satisfy conditions where the melt viscosity of the aliphatic polyester composition at the discharge port is from 100 to 2000 Pa·s and conditions where the concentration of unreacted cyclic esters in the obtained aliphatic polyester composition is less than 2 wt. %, the temperature differs based on the type and molecular weight of the aliphatic polyester, but for example, if the weight average molecular weight of the polyglycolic acid is 160000, the temperature is preferably 200° C. to 265° C., and more preferably 210° C. to 265° C. When the temperature is 265° C. or lower, the melt viscosity of the content will not be reduced, and therefore, thermolysis of the content can be prevented from occurring. Furthermore, when the temperature is 200° C. or higher, the melt viscosity of the content on the discharge side will not increase, and therefore, transportability is enhanced.

As a condition other than the aforementioned condition of satisfying an unreacted cyclic ester concentration in the aliphatic polyester composition of less than 2 wt. %, the cyclic ester is preferably sufficiently polymerization reacted such that the reaction between the cyclic ester and aliphatic polyester reaches a state of equilibrium, if the temperature at the discharge port of the extruder is lower than 265° C. Examples include setting the amount of the molecular weight adjusting agent or polymerization catalyst added to the extruder to be within the aforementioned preferred range, introducing the cyclic ester or the like to the extruder and then setting the time until the cyclic ester is discharged from the discharge port in the extruder (hereinafter, referred to as residence time in the extruder) within a preferred range. The residence time in the extruder is preferably from five minutes to 10 hours, and more preferably from 10 minutes to five hours. Thereby, the cyclic ester is sufficiently polymerization reacted, and a reaction between the cyclic ester and aliphatic polyester easily reaches a state of equilibrium.

Note that the time for reaction between the cyclic ester and the aliphatic polyester to reach a state of equilibrium is different based on the type of manufactured aliphatic polyester, but can be easily confirmed as follows. Herein, a case where a polyglycolic acid composition is manufactured from a glycolide is described. In order to manufacture a polyglycolic acid composition from a glycolide, a glycolide, tin dichloride dihydrate (90 ppm by mass with regard to the glycolide), and dodecyl alcohol (0.26 mol % with regard to the glycolide) were mixed and reacted at 170° C. Note that the free acid concentration in the glycolide that was used was 4 eq/t. A polymerization reaction was performed until the reaction rate (unit: %) reached 100%, and then the relationship between the polymerization time (unit: min) and the reaction rate (unit: %) was plotted on a graph (FIG. 2). As shown in FIG. 2, the polymerization reaction was found to reach equilibrium at approximately 30 minutes. Furthermore, when the amount of the dichloride dihydrate catalyst was from 90 ppm to 180 ppm, equilibrium was reached in 15 minutes. Based therefrom, the polymerization rate and catalyst amount were found to have a primary proportional relationship. Furthermore, if the temperature is from 170° C. to 180° C., equilibrium is reached in approximately 20 minutes.

The time for a reaction between the cyclic ester and aliphatic polyester to reach a state of equilibrium was similarly confirmed.

Extruder

The extruder used in the manufacturing method of an aliphatic polyester according to the present embodiment is preferably provided with a cylinder and a screw inserted in the cylinder in order to appropriately knead a cyclic ester or the like between a raw material introducing port and discharge port, and to extrude an aliphatic polyester from the discharge port at an appropriate rate. Examples includes single screw extruders, twin screw extruders, and the like, and from the perspective of transportability, a twin screw extruder is preferred.

A cylinder and a die head part (or a discharge port) has a plurality of zones in which the temperature can be independently controlled from the raw material supply port to the discharge port. In the manufacturing method of an aliphatic polyester according to the present invention, an extruder is preferably used where the temperature can be set in each region from the raw material supply port to the discharge port so as to gradually increase the temperature in two or more stages from the raw material supply port to the discharge port. Note that the segment number which is the number of zones in which the temperature can be controlled is preferably larger, and for example, is preferably within a range of 3 to 30, and more preferably within a range of 3 to 20.

An L/D value (L represents the length of an extruder screw, and D represents the inner diameter of the screw) is preferably 5 to 100, and more preferably 10 to 50. When the L/D value is 100 or less, the residence time in the extruder does not increase, and the content does not increase, and therefore, loading is less likely to be applied to the screw motor. Furthermore, when the L/D value is 5 or more, the residence time in the extruder of content for sufficiently reacting the cyclic ester or the like is easily ensured. Therefore, when the L/D value is within the aforementioned preferred range, the cyclic ester or the like is sufficiently reacted, and loading is less likely to be applied to the screw motor.

The screw rotational speed is preferably within a range that can achieve a high reaction rate, which is preferably within a range of 3 rpm to 100 rpm, and more preferably within a range of 5 rpm to 50 rpm. When the rotational speed is 100 rpm or less, the content in the extruder is not excessively extruded, and therefore, the reaction of the content in the extruder for sufficiently reacting the cyclic ester or the like can be ensured. Furthermore, when the rotational speed is 3 rpm or higher, polymerization of the cyclic ester or the like does not proceed in a segment on a raw material supply side, and therefore, blockage does not occur in the extruder, and loading is not applied to the motor. Furthermore, polymerization does not excessively proceed while air is trapped by filling the cyclic ester or the like, and therefore, bubbles do not remain in the obtained aliphatic polyester composition. Therefore, when in the aforementioned preferred range, the cyclic ester or the like is sufficiently reacted, and problems can be prevented from occurring in the extruder or with the aliphatic polyester composition.

The screw shape is not particularly limited, but from the perspective of transportability, a transporting portion is preferably a full flight-shaped or sub-flight-shaped screw, and a full flight-shaped screw is more preferable.

The extruder used in the present embodiment is provided with a gear pump between a die and the tip end of the extruder. Based on this form, the aliphatic polyester composition is extruded by the screw at the discharge port, and therefore, the discharge stability of the aliphatic polyester composition can be enhanced.

Aliphatic Polyester Composition

The aliphatic polyester composition according to the present embodiment is manufactured by ring-opening polymerizing a cyclic ester in an extruder. The aliphatic polyester can be obtained by a method using dehydration condensation of an α-hydroxycarboxylic acid, or a method using ring-opening polymerization of a cyclic ester. Of these, an aliphatic polyester with a high molecular weight can be more efficiently manufactured by the method using ring-opening polymerization. Furthermore, the aliphatic polyester can be continuously manufactured by ring-opening polymerizing the cyclic ester in the extruder.

Examples of the aliphatic polyester composition include polyglycolic acid compositions, polylactic acid compositions, polycaprolactone compositions, polyhydroxybutyrates, and the like, where the polyglycolic acid compositions, polylactic acid compositions, or polycaprolactone compositions are preferable, and polyglycolic acid compositions are more preferable. The manufacturing method according to the present embodiment can be particularly preferably applied to manufacturing a polyglycolic acid composition.

The molecular weight of the generate aliphatic polyester is preferably within a range of 100000 to 250000, and more preferably within a range of 120000 to 240000. When the molecular weight is 100000 or greater, physical properties such as strength and the like of the generated aliphatic polyester can be prevented from being reduced. When the molecular weight is 250000 or less, the melt viscosity of the generated aliphatic polyester composition can be prevented from increasing excessively. Therefore, the aliphatic polyester with the aforementioned range can be manufactured to obtain from a cyclic ester an aliphatic polyester composition with excellent physical properties and a high reaction rate.

Note that an aliphatic polyester is clearly manufactured based on the manufacturing method of the aforementioned aliphatic polyester composition. Therefore, the manufacturing method of the aforementioned aliphatic polyester composition is clearly a manufacturing method of an aliphatic polyester.

Manufacturing Method of an Aliphatic Polyester Molded Product

Step 1

After the aliphatic polyester composition is manufactured, the aliphatic polyester composition is molded by a die of a die head part. Thereby, an aliphatic polyester molded product is obtained from the discharge port of the extruder.

Herein, examples of the shape of the obtained aliphatic polyester molded product include a fibrous form, sheet form, film form, rod form, plate form, pellet form, tube form, and strand form. A fibrous form, sheet form, film form, rod form, plate form, pellet form, and strand form are preferable, and a fibrous form, rod form, and sheet form are more preferable. Thereby, a practical aliphatic polyester molded product can be obtained from a cyclic ester using one extruder.

Step 2

Next, the obtained aliphatic polyester molded product is maintained at a constant temperature.

Herein, the temperature when maintaining is preferably higher than the temperature of the melting point of the cyclic ester and less than the temperature of the melting point −20° C. of the aliphatic polyester composition, and more preferably higher than a temperature of a melting point +20° C. of the cyclic ester and less than the temperature of the melting point −30° C. of the aliphatic polyester composition. When the temperature is within the aforementioned preferred range, the aliphatic polyester composition can be maintained in a solid phase condition, and when a polymerization reaction is advanced or the cyclic ester is volatilized from the aliphatic polyester composition, the concentration of unreacted cyclic esters in the aliphatic polyester composition can be reduced.

The concentration of unreacted cyclic esters in the aliphatic polyester molded product after maintaining is preferably less than 0.2 wt. %, and more preferably 0.1 wt. %. When the concentration is less than 0.2 wt. %, a higher quality aliphatic polyester molded product is obtained.

Herein, in order for the concentration of unreacted cyclic esters in the aliphatic polyester molded product after maintaining to be less than 0.2 wt. %, the maintaining time at the aforementioned temperature is preferably from 10 minutes to 10 hours, and more preferably from 30 minutes to five hours.

Furthermore, examples of locations of maintaining at a constant temperature include ovens, hot plates, oil baths, and the like, and ovens are more preferable. Thereby, the temperature can be more uniform.

When maintaining at a constant temperature, maintaining is preferably performed in a dry atmosphere in order to prevent hydrolysis. Examples of maintaining in a dry atmosphere include, maintaining in dry air, nitrogen, argon, or other dry gas, maintaining under reduced pressure, and the like.

Note that in the present embodiment, an aliphatic polyester molded product is maintained, but with the present invention, the aliphatic polyester composition may be maintained at a constant temperature without molding into a certain shape.

Furthermore, the obtained aliphatic polyester molded product can be two-dimensionally molded, and can be processed into a molded product with various shapes.

The present invention is not limited to the aforementioned embodiments, and various modifications are possible within a scope indicated by the range. An embodiment obtained by appropriately combining technical means disclosed in different embodiments are also included in the technical scope of the present invention.

Note that with the manufacturing method of the aforementioned aliphatic polyester molded product, an aliphatic polyester molded product can clearly be manufactured from the aliphatic polyester itself.

Summary

A manufacturing method of an aliphatic polyester according to the present invention is a method of continuously manufacturing an aliphatic polyester composition, including a step of supplying a cyclic ester, molecular weight adjusting agent, and polymerization catalyst to an extruder and then polymerizing in the extruder; where the temperature in the extruder is gradually increased in two or more stages from a raw material supply port to a discharge port, the temperature at the discharge port is a temperature where the melt viscosity of the composition at the discharge port is from 100 to 2000 Pa·s, the free acid concentration in the cyclic ester is 10 eq/t or less, and the unreacted cyclic ester concentration in the aliphatic polyester composition is less than 2 wt. %.

Furthermore, in the manufacturing method of an aliphatic polyester composition according to the present invention, the aliphatic polyester composition is preferably a polyglycolic acid composition, polylactic acid composition, or polycaprolactone composition.

Furthermore, in the manufacturing method of an aliphatic polyester composition according to the present invention, the aliphatic polyester composition is preferably a polyglycolic acid composition.

Furthermore, in the manufacturing method of an aliphatic polyester composition according to the present invention, the molecular weight of the aliphatic polyester is preferably from 100000 to 250000.

Furthermore, in the manufacturing method of an aliphatic polyester composition according to the present invention, the amount of the polymerization catalyst with regard to the cyclic ester is preferably less than 600 ppm by mass ratio.

Furthermore, in the manufacturing method of an aliphatic polyester composition according to the present invention, the molecular weight adjusting agent is preferably a dihydric alcohol or higher.

Furthermore, the method of manufacturing an aliphatic polyester composition according to the present invention preferably further includes a step of maintaining the aliphatic polyester composition discharged from the discharge port at a temperature higher than the melting point of the cyclic ester and a temperature lower than the melting point of the aliphatic polyester minus 20° C.

A manufacturing method of an aliphatic polyester molded product according to the present invention includes a step of molding an aliphatic polyester composition manufactured by the aforementioned manufacturing method of an aliphatic polyester composition into a fibrous form, sheet form, film form, rod form, plate form, or pellet form.

Furthermore, the method of manufacturing an aliphatic polyester molded product according to the present invention preferably further includes a step of maintaining the aliphatic polyester molded product discharged from the discharge port at a temperature higher than the melting point of the cyclic ester and a temperature lower than the melting point of the aliphatic polyester minus 20° C.

### EXAMPLES

Examples of Manufacturing Aliphatic Polyester Composition and Molded Product

### Example 1

Step 1

In a dry room controlled to a dew point of −40° C. or lower, 1.2 kg of glycolide (manufactured by Kureha Corporation) was placed in a beaker and then completely dissolved by heating the beaker to 100° C. 1.39 g of propylene glycol (manufactured by Junsei Chemical Co., Ltd.) (0.18 mol % with regard to glycolide) and 108 mg of tin dichloride dihydrate (manufactured by Kanto Chemical Co., Inc.) were added and stirred in the glycolide melt until completely visually uniform, and then further stirred for five minutes. The melt was quickly moved into an aluminum container, solidified by cooling at room temperature, and then pulverized to a size of approximately 10 mm. Note that the free acid concentration in the glycolide that was used was 2 eq/t.

Herein, if the free acid of the glycolide is assumed to be glycolic acid, the amount of hydroxyl groups derived from the glycolic acid is 0.02 mol % with regard to the glycolide. The glycolic acid has the same function as the molecular weight adjusting agent. Therefore, the total amount between amount α of hydroxyl groups of a free acid with regard to the glycolide and amount β of the molecular weight adjusting agent (propylene glycol) with regard to the glycolide is 0.2 mol % with regard to the glycolide. The results are shown in Table 1.

Step 2

The pulverized product obtained in step 1 was introduced at a rate of approximately 7 g/min using a feeder into the raw material supply port of the extruder provided with a gear pump between the die and the tip end of the extruder. The temperature in the cylinder was set to increase by stage in two or more stages from the raw material supply port to the discharge port, in accordance with the staged temperature conditions shown in Table 1. Herein, C1 to C4 represent temperatures at a position where a shaft part is equally divided into four parts in order from the inlet (raw material supply port) of the shaft, and GP represents the temperature of the gear pump. Note that in the present Examples and Comparative Examples, the temperature in one stage was considered to increase at one point where the temperature changes by 10° C. or higher, in a range from C1 to C2, C2 to C3, C3 to C4, and C4 to GP. Therefore, in Example 1, the temperature increases by stage in four stages from the raw material supply port to the discharge port.

After introducing raw materials for approximately 30 minutes, a fibrous polyglycolic acid (hereinafter, PGA) molded product began to be discharged from the nozzle-shaped die (hereinafter, die outlet) of the die head part on a tip end of the gear pump of the extruder. Note that PGA molded product indicates a product in which a PGA composition obtained in the extruder was molded in a die. The physical properties of the obtained PGA molded product are shown in Table 2. Change in the discharge rate and resin pressure was not observed during an operation of approximately two hours, and therefore, the PGA composition and molded product were confirmed to be stably and continuously manufactured.

Note that the following was used as the extruder.
Extruder

Machine: FET lab extruder manufactured by Fiber Extrusion Technology

L (extruder screw length): 75 cm

D (screw inner diameter): 25 mmφ

L/D=30

Screw: Single-row, single-screw full flight screw

Screw rotational speed: 14 rpm

Cylinder and Gear Pump Temperature (° C.): C1 125/C2 170/C3 200/C4 215/GP 225

Nozzle: 0.25 mmφ×1 mmL×24 hole

Gear Pump Discharge Rate: 10 cc/rev

### Example 2

As shown in Table 1, a PGA molded product was obtained using the same method as Example 1, except that the cylinder and gear pump temperatures (° C.) were changed to C1 125/C2 170/C3 200/C4 215/GP 240 such that the temperature increased by stage in four stages from the raw material supply port to the discharge port. The physical properties of the obtained PGA molded product are shown in Table 2. Furthermore, change in the discharge rate and resin pressure was not observed during an operation of approximately two hours, and therefore, the PGA composition and molded product were confirmed to be stably and continuously manufactured.

### Example 3

The PGA molded product obtained in Example 2 was maintained for one hour in a 170° C. oven into which dry air at a dew point of minus 40° C. was blown. The physical properties of the obtained PGA molded product are shown in Table 2. As shown in Table 2, the unreacted glycolide concentration (hereinafter, residual GL concentration) in the obtained PGA molded product was confirmed to have reduced from 1.1 wt. % to 0.1 wt. %.

### Example 4

As shown in Table 1, a PGA molded product was obtained using the same method as Example 1, except that the cylinder and gear pump temperatures (° C.) were changed to C1 125/C2 220/C3 220/C4 220/GP 240 such that the temperature increased by stage in two stages from the raw material supply port to the discharge port. The physical properties of the obtained PGA molded product are shown in Table 2. Furthermore, change in the discharge rate and resin pressure was not observed during an operation of approximately two hours, and therefore, the PGA composition and molded product were confirmed to be stably and continuously manufactured.

### Example 5

As shown in Table 1, a PGA molded product was obtained using the same method as Example 4, except that the added amount of tin dichloride dihydrate was 360 mg. The physical properties of the obtained PGA molded product are shown in Table 2. Furthermore, change in the discharge rate and resin pressure was not observed during an operation of approximately two hours, and therefore, the PGA composition and molded product were confirmed to be stably and continuously manufactured.

### Comparative Example 1

As shown in Table 1, a PGA molded product was obtained using the same method as Example 1, except that the cylinder and gear pump temperatures (° C.) were changed to C1 190/C2 230/C3 230/C4 220/GP 200. The physical properties of the obtained PGA molded product are shown in Table 2. Furthermore, a PGA molded product was stably obtained for several minutes from when the PGA molded product started discharging from the discharge port. However, thereafter, the PGA molded product could not be discharged, and the operation stopped.

### Comparative Example 2

As shown in Table 1, a PGA molded product was obtained using the same method as Example 1, except that the cylinder and gear pump temperatures (° C.) were changed to C1 80/C2 220/C3 220/C4 220/GP 220 such that the temperature increased by stage in one stage from the raw material supply port to the discharge port. The physical properties of the obtained PGA molded product are shown in Table 2. Furthermore, a PGA molded product was stably obtained for several minutes from when the PGA molded product started discharging from the discharge port. However, thereafter, the PGA molded product could not be discharged, and the operation stopped.

### Comparative Example 3

As shown in Table 1, a PGA molded product was obtained using the same method as Example 1, except that the added amount of the propylene glycol was set to 0.76 g (0.10 mol % with regard to glycolide). The physical properties of the obtained PGA molded product are shown in Table 2. Furthermore, a PGA molded product was stably obtained for several minutes from when the PGA molded product started discharging from the discharge port. However, thereafter, the PGA molded product could not be discharged, and the operation stopped.

### Comparative Example 4

As shown in Table 1, a PGA composition was obtained using the same method as Example 4 except that the added amount of propylene glycol was changed to 0.48 g (0.06 mol % with regard to glycolide) using glycolide with a free acid concentration of 12 eq/t (hydroxyl groups of a free acid is 0.14 mol % with regard to glycolide). The physical properties of the obtained PGA molded product are shown in Table 2. From Table 1, the melt viscosity of the die outlet was found to be low as compared to other examples and comparative examples. Furthermore, operation for approximately two hours was possible, but the discharge rate was unstable, and fluctuation was large.

TABLE 1

| | | | | Amount β of | | | | | | | |
|---|---|---|---|---|---|---|---|---|---|---|---|
| | | Amount α of | | Molecular | | | | | | | |
| | | Hydroxyl | | Weight | Amount | | | | | | |
| | | Groups of a | | Adjusting | of α + β | | | | | | Melt |
| | | Free Acid | Amount | Agents With | With | | | | | | Viscosity |
| | Free Acid | With Regard | of | Regard to | Regard to | Extrusion | | | | | at Die |
| | Concentration | to Glycolide | Catalysts | GLycolide | Glycolide | Temperature (° C.) | | | | | Outlet |
| | (eq/t) | (mol/%) | (ppm) | (mol %) | (mol %) | C1 | C2 | C3 | C4 | D | (Pa · s) |
| Example 1 | 2 | 0.02 | 90 | 0.18 | 0.20 | 125 | 170 | 200 | 215 | 225 | 760 |
| Example 2 | 2 | 0.02 | 90 | 0.18 | 0.20 | 125 | 170 | 200 | 215 | 240 | 560 |
| Example 4 | 2 | 0.02 | 90 | 0.18 | 0.20 | 125 | 220 | 220 | 220 | 240 | 370 |
| Example 5 | 2 | 0.02 | 300 | 0.18 | 0.20 | 125 | 220 | 220 | 220 | 240 | 490 |
| Comparative | 2 | 0.02 | 90 | 0.18 | 0.20 | 190 | 230 | 230 | 220 | 200 | 1100 |
| example 1 | | | | | | | | | | | |
| Comparative | 2 | 0.02 | 90 | 0.18 | 0.20 | 80 | 220 | 220 | 220 | 220 | 740 |
| example 2 | | | | | | | | | | | |
| Comparative | 2 | 0.02 | 90 | 0.10 | 0.12 | 125 | 170 | 200 | 215 | 225 | 2100 |
| example 3 | | | | | | | | | | | |
| Comparative | 12 | 0.14 | 90 | 0.06 | 0.20 | 125 | 220 | 220 | 220 | 240 | 40 |
| example 4 | | | | | | | | | | | |

Herein, the free acid concentration in the glycolide was determined by the following method. In other words, approximately 5 g of glycolide was accurately weighed and then dissolved in a mixed solvent of 25 mL of acetone and 25 mL of methanol. The mixed solvent was neutralized and titrated by adding 0.003 M of a sodium methoxide/methanol solution using an automatic titrating device (COM-1600ST manufactured by Hiranuma Sangyo Co., Ltd.). The number of equivalents (unit: eq/t) of free acids present per 1 t of glycolide was calculated from the neutralization point that was determined.

Furthermore, the melt viscosity of the die outlet was determined by the following method. In other words, a Capillograph 1-C (manufactured by Toyo Seiki Seisaku-sho, Ltd.) equipped with a capillary (1 mmφ×10 mmL) was used for measurement. Approximately 20 g of the obtained PGA molded products were introduced and maintained for five minutes in the device heated to the same temperature as the set temperature of the die in Examples 1 to 5 and Comparative Examples 1 to 3, and then the melt viscosity at a shear rate of 121 sec⁻¹ was measured.

TABLE 2

| | | PGA | Weight |
|---|---|---|---|
| | Residual GL | Molecular | Reduction |
| | Concentration | Weight | Percentage |
| | (wt. %) | (×10⁴) | (%) |
| Example 1 | 1.1 | 16.6 | 0.3 |
| Example 2 | 1.1 | 16.0 | 0.3 |
| Example 3 | 0.1 | 15.7 | 0.3 |
| Example 4 | 1.0 | 14.7 | 0.3 |
| Example 5 | 1.1 | 16.1 | 0.3 |
| Comparative example 1 | 3.4 | 16.0 | 1.0 |
| Comparative example 2 | 1.6 | 15.7 | 0.4 |
| Comparative example 3 | 1.9 | 22.5 | 0.4 |
| Comparative example 4 | 18 | 12.2 | 7.4 |

Herein, the residual GL concentration was determined by the following method. In other words, a dimethyl sulfoxide solution (0.4 mg/2 mL) was added to 100 mg of the obtained PGA molded product, dissolved by heating for approximately 10 minutes at 150° C., and cooled to room temperature, and then filtering was performed. The filtrate was measured by gas chromatography using a GC-2010 (manufactured by Shimadzu Corporation). Note that in the gas chromatography measurement, an injection temperature was 180° C., and the column temperature was maintained for five minutes at 150° C., increased to 270° C. at a rate of 20° C./min, and then maintained for three minutes.

Furthermore, the PGA molecular weight was determined by the following method. In other words, 0.5 mL of dimethyl sulfoxide was added to approximately 10 mg the obtained PGA molded product, dissolved by heating at 150° C., and then cooled to room temperature. The solution was measured by gas chromatography using a Shodex GPC-104 manufactured by Showa Denko KK (detector: RI, sample column: HFIF-606M, two columns). Note that a hexafluoroisopropyl alcohol containing 5 mM of sodium trifluoroacetate was used as the Shodex GPC-104 solvent. Furthermore, the molecular weight was calculated using polymethyl methacrylate as a molecular weight standard substance.

Furthermore, the weight reduction percentage was determined by the following method. In other words, approximately 10 mg of the obtained PGA molded product was set to TGA 855e (manufactured by Mettler-Toledo International Inc.), and then the weight of the PGA molded product at 50° C. was measured. Next, the temperature was increased from 50° C. to 200° C. at 2° C./min in a nitrogen flowing condition at a rate of 10 mL/min. Furthermore, the weight of the PGA molded product at 200° C. was measured. The ratio of the weight of the PGA molded product at 200° C. with regard to the weight of the PGA molded product at 50° C. was determined, and the ratio was set as the weight reduction percentage.

### INDUSTRIAL APPLICABILITY

The present invention can be used in manufacturing an aliphatic polyester composition and molded product.

1. A method of continuously manufacturing an aliphatic polyester composition, comprising a step of supplying a cyclic ester, molecular weight adjusting agent, and polymerization catalyst to an extruder and then polymerizing in the extruder; wherein
the temperature in the extruder is gradually increased in two or more stages from a raw material supply port to a discharge port,
the temperature at the discharge port is a temperature where the melt viscosity of the composition at the discharge port is from 100 to 2000 Pa·s,
the free acid concentration in the cyclic ester is 10 eq/t or less, and
the unreacted cyclic ester concentration in the aliphatic polyester composition is less than 2 wt. %.

2. The method of manufacturing an aliphatic polyester composition according to claim 1, wherein the aliphatic polyester composition is a polyglycolic acid composition, polylactic acid composition, or polycaprolactone composition.

3. The method of manufacturing an aliphatic polyester composition according to claim 1, wherein the aliphatic polyester composition is a polyglycolic acid composition.

4. The method of manufacturing an aliphatic polyester composition according to claim 1, wherein the molecular weight of the aliphatic polyester is from 100000 to 250000.

5. The method of manufacturing an aliphatic polyester composition according to claim 1, wherein the amount of the polymerization catalyst with regard to the cyclic ester is less than 600 ppm by mass ratio.

6. The method of manufacturing an aliphatic polyester composition according to claim 1, wherein the molecular weight adjusting agent is a dihydric alcohol or higher.

7. The method of manufacturing an aliphatic polyester composition according to claim 1, further comprising a step of maintaining the aliphatic polyester composition discharged from the discharge port at a temperature higher than the melting point of the cyclic ester and lower than the melting point −20° C. of the aliphatic polyester.

8. The method of manufacturing an aliphatic polyester molded product, comprising a step of molding the aliphatic polyester composition manufactured by the method of manufacturing an aliphatic polyester composition according to claim 1 into a fibrous form, sheet form, film form, rod form, plate form, or pellet form.

9. The method of manufacturing an aliphatic polyester molded product according to claim 8, further comprising a step of maintaining the aliphatic polyester molded product discharged from the discharge port at a temperature higher than the melting point of the cyclic polyester and a temperature lower than the melting point −20° C. of the cyclic polyester.

10. A method of continuously manufacturing an aliphatic polyester, comprising a step of supplying a cyclic ester, molecular weight adjusting agent, and polymerization catalyst to an extruder and then polymerizing in the extruder;
wherein
the temperature in the extruder is gradually increased in two or more stages from a raw material supply port to a discharge port,
the temperature at the discharge port is a temperature where the melt viscosity of the aliphatic polyester at the discharge port is from 100 to 2000 Pa·s,
the free acid concentration in the cyclic ester is 10 eq/t or less, and
the unreacted cyclic ester concentration in the aliphatic polyester is less than 2 wt. %.
